(19) United States
(12) Patent Application Publication
(10) Pub. No.: US 2008/0123513 A1
(43) Pub. Date: May 29, 2008

(54) Method and a Device for Retrieving a Transport Format Indicator, and Mobile Phone

(75) Inventors: Oliver Mielo, Saint Laurent Du Var (FR); Sebastien Mackaie-Blanchi, Nice (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/576,460

(22) PCT Filed: Sep. 15, 2005
(86) PCT No.: PCT/IB05/53034

§ 371 Date: Oct. 8, 2007

(30) Foreign Application Priority Data
Sep. 30, 2004 (EP) 04300640.2

(51) Int. Cl. H04J 11/00

(52) U.S. Cl. 370/203

(57) ABSTRACT

A method of retrieving a transport format indicator (TFIᵢ) from a calculated transport format combination (CTFC), which calculated transport format combination is computed by means of the following relation formula (I) where: —Lⱼ is the number of available transport formats for a transport channel j (TrCHⱼ); —Pᵢ is a weight associated with transport channel i (TrCHᵢ); and—TFIᵢ is the transport format indicator of transport channel i, the value TFIᵢ being equal to a whole part of a division of an integer (Fᵢ) by weight Pᵢ, the integer Fᵢ being a function of the CTFC value, wherein the whole part is determined (90) by repeatedly decrementing the integer Fᵢ by the weight Pᵢ.

### FIELD OF THE INVENTION

The present invention relates to optimised extraction of transport formats indicator.

### BACKGROUND OF THE INVENTION

Third-generation wireless communication systems have been defined by the third generation partnership project (3GPP). For example, a 3GPP-defined communication system is the UMTS (Universal Mobile Telecommunication System).

The defined system allows the transmission of a wide range of services, from high data rates such as video-on-demand to low data rates such as speech. The implication is that the quantity of data on transport channels can be managed dynamically.

Three types of channels are defined in such systems: logical channels, transport channels, and physical channels. The logical channels are mapped onto transport channels. Several transport channels are multiplexed in a coded composite transport channel and mapped onto one or more physical channels. For example, the physical channel includes information sent on an air interface.

Hereinafter, the terminology and acronyms defined by the 3GPP are used.

In a 3GPP-defined communication system, on the transmitting side, a transport format combination (TFC) is chosen in a transport format combination set (TFCS) to dynamically manage the quantity of data transmitted on transport channels. A TFC is a combination of transport format indicators (TFIᵢ). Each TFIᵢ codes and identifies a transport format (TFⱼ) used by a transport channel (TrCHᵢ). For example, the TFCS is a table defining every transport format combination available to transmit data.

A MAC (Medium Access Control) layer selects which transport format combination in this set is to be used to transmit data as a function of the flow rate required for each transport channel TrCHᵢ. The MAC layer is a sublayer of the second layer on the transmitting side.

A calculated transport format combination (CTFC) is then computed from the selected transport format combination TFC. Next, a transport format combination indicator (TFCI) corresponding to the CTFC is transferred, in association with the transmitted data, to user equipment (UE).

On the receiving side, the transport format TFⱼ used is recognized for each transport channel TrCHᵢ to perform format conversion from physical channels to transport channels. This is done by extracting the TFCI transmitted in association with the transmitted data and by recognizing the corresponding CTFC. Based on the recognized CTFC, the transport format indicator TFIᵢ is retrieved for each transport channel TrCHᵢ. Finally, a format conversion from physical channels to transport channel is performed using the retrieved TFIᵢ.

Further details on transport formats can be found on the 3^{rd} Generation Partnership Project (3GPP) web site at http://www.3gpp.org.

Ericsson proposed an example of a known method for retrieving TFIᵢ from CTFC, during meeting No. 7 of the TSG-RAN Working Group 1, in Hanover, Germany, which took place from Aug. 30 to Sep. 3, 1999. A summary of the proposed method can be found in the Ericsson document TSGR1#7(99)b33.

In this method, the determination of each TFIᵢ requires the division of an integer value by a weight and the resulting whole part of the number is calculated.

Therefore, it is necessary to carry out a division operation and then a flooring operation to implement this method, which makes it slow or require expensive processors.

### SUMMARY OF THE INVENTION

Accordingly, it is an object of the invention to provide a faster method for retrieving a transport format indicator TFIᵢ from a CTFC.

The invention provides a method for retrieving TFIᵢ from a CTFC, wherein the calculated transport format combination has been computed by means of the following relation:

$${P}_{i} = {\prod }_{j = 0}^{i - 1} {L}_{j}$$

$$CTFC = {\sum }_{i = 1}^{I} {TFI}_{i} * {P}_{i}$$

where:
L₀=1;
i is an index varying by integer steps from 1 to I;
I is the total number of transport channels (TrCHⱼ) in one coded composite transport channel;
Lⱼ is the number of available transport formats for a transport channel j (TCⱼ);
Pᵢ is a weight associated with transport channel i (TrCHᵢ); and
TFIᵢ is the transport format indicator of transport channel i, the value TFIᵢ being equal to a whole part of a division of an integer (F) by weight Pᵢ, the value of the integer F being a function of the CTFC value,
   wherein the whole part is determined (90) by repeatedly decrementing the integer F by the weight Pᵢ.

Repeated decrementing operations are much faster than one division operation and one flooring operation. Therefore, the above method is faster than known methods.

The features as defined in claims 2 and 3 have the advantages of further reducing the processing time.

The invention also relates to a device implementing the above method and to a mobile phone incorporating such a device.

This and other aspects of the invention will be apparent from the following description, drawings, and claims.

### BRIEF DESCRIPTION OF THE DRAWINGS

FIG. 1 is a schematic diagram of a device for retrieving TFIᵢ from a CTFC;

FIG. 2 is a flowchart of a method for exchanging transport format information between a transmitter and a receiver; and

FIG. 3 is a flowchart of an algorithm for retrieving TFIᵢ used in the method of FIG. 2.

### DETAILED DESCRIPTION

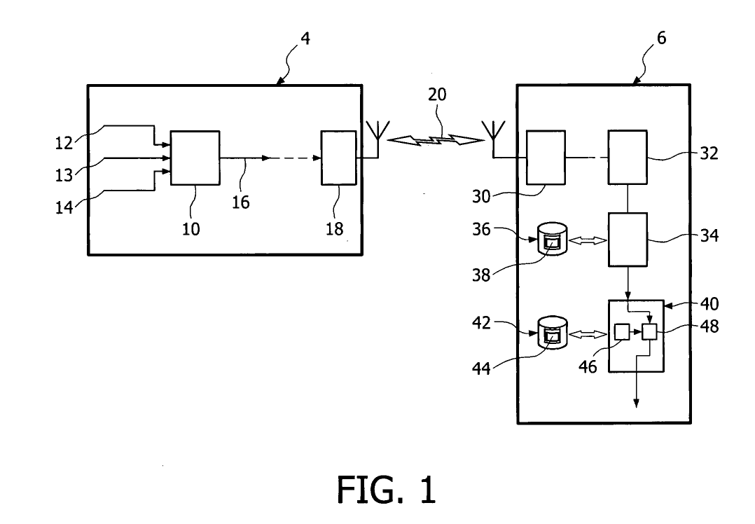

FIG. 1 shows an UMTS frequency-division duplex communication system (UMTS 3G-FDD). FIG. 1 shows only the details necessary to understand the invention.

This system includes a base station 4 and several user stations. For simplicity, only one user station 6 is shown. For example, user station 6 is a mobile phone.

Base station 4 includes a multiplexing unit 10 able to multiplex several transport channels into a coded composite transport channel. Here three transport channels 12 to 14 to be multiplexed are represented and only one coded composite transport channel 16 is shown.

Each transport channel is characterized by semi-static parameters such as the transmission time interval (TTI) and by dynamic parameters such as the transport format TFⱼ.

Base station 4 also includes a radio transceiver 18 to convert physical channels into radio signal 20 transmitted over the air to user station 6.

User station 6 has a radio transceiver 30 to receive radio signals 20. It also features a TFCI extracting unit 32 linked to a CTFC recognizing unit 34. Recognizing unit 34 is connected to a memory 36, which contains a table 38. Table 38 associates a corresponding value for the CTFC with each value of the extracted TFCI.

User station 6 also includes a TFIᵢ retrieving unit 40, which is capable of retrieving the TFIᵢ associated with each transport channel TrCHᵢ that uses the recognized CTFC. For each transport channel TrCHᵢ, unit 40 is connected to a memory 42 that includes the following information:
a number Lⱼ of available transport formats TFⱼ for transport channel TrCHᵢ; and
   a total number I of transport channels multiplexed in channel 16.

Unit 40 includes a weight computation module 46 and a TFIᵢ determining module 48 to retrieve the TFIᵢ of each transport channel TrCHᵢ.

Module 46 computes a weight Pᵢ according to the following relation:

$${P}_{i} = {\prod }_{j = 0}^{i - 1} {L}_{j} , \\ where i = 1 , 2 , … I , and {L}_{0} = 1 \qquad ( 1 )$$

where Lⱼ and I are the symbols previously defined.

Module 48 determines the whole part of the division of an integer number Fᵢ by the weight Pᵢ.

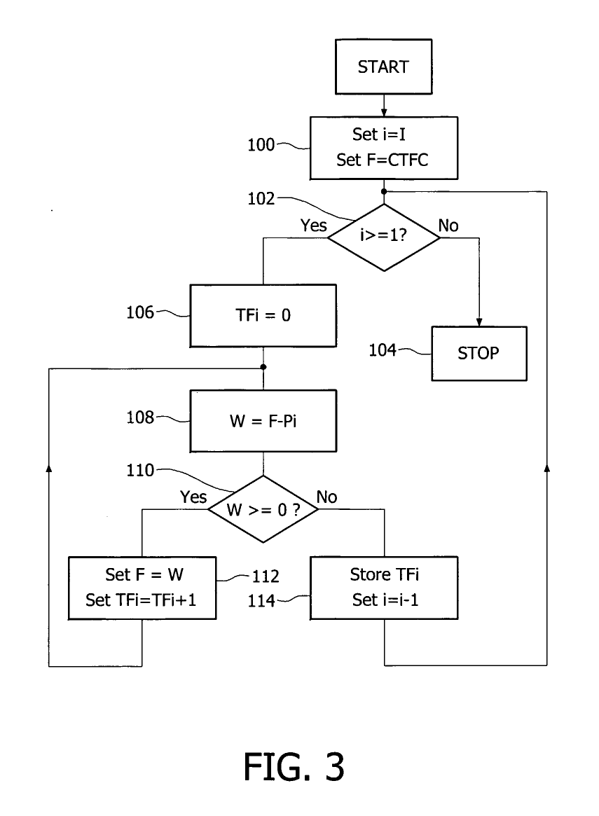

More details on modules 46 and 48 will be given with reference to FIG. 3.

Unit 40 is used in a processor that has no dedicated multiplier unit to perform a fast division such as an ARM9 processor.

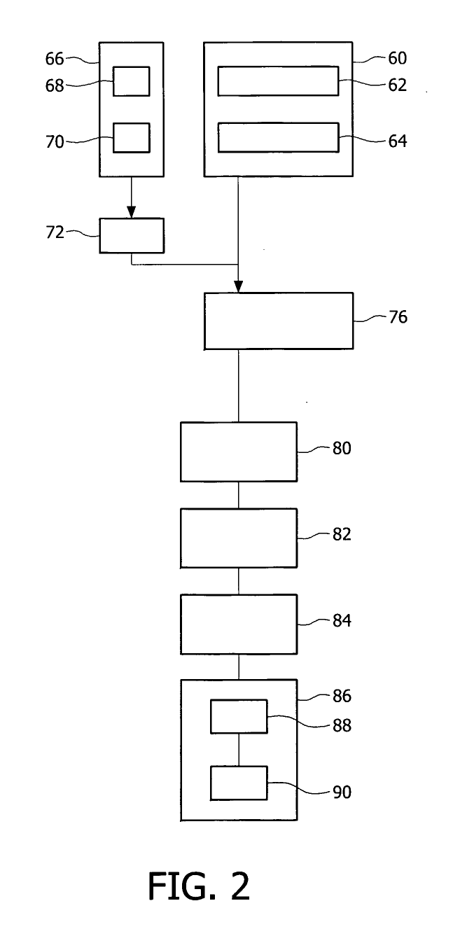

The operation of the system shown in FIG. 1, will now be described with reference to FIG. 2.

In step 60, transport channels 12 to 14 are converted to physical channels. More precisely, during an operation 62, transport channels 12 to 14 are multiplexed to form the coded composite transport channel 16. Then, during an operation 64, channel 16 is mapped onto physical channels.

In parallel, in a step 66, base station 4 computes a CTFC from the currently selected TFC.

During step 66, in an operation 68, the weight Pᵢ for each transport channel TrCHᵢ is calculated by means of relation (1).

Then, during an operation 70, the value of CTFC is computed by means of the following relation:

$$CTFC = {\sum }_{i = 1}^{I} {TFI}_{i} * {P}_{i} \qquad ( 2 )$$

where:

Pᵢ is the weight associated with transport channel TrCHᵢ; and

TFIᵢ is the transport format indicator associated with transport channel TrCHᵢ.

The value of TFIᵢ is, for example, an integer number identifying a particular transport format for one transport channel.

For example, let it be assumed that the number Lᵢ of available transport formats for each channel 12 to 14 is equal to “3” and that the currently used transport format indicator TFIᵢ for transport channels 12, 13 and 14 is equal to “2”, “1” and “1” respectively. During operation 68, the calculated values of weights Pᵢ for each channel 12 to 14 are as follows:

P₁=L₀=10

P₂=L₀*L₁=30

P₃=L₀*L₁*L₂=3*3=9

where:
P₁, P₂ and P₃ are the weights associated with transport channels 12, 13, and 14, respectively; and
L₁ and L₂ are the numbers of available transport formats for transport channels 13 and 14, respectively.

Using the previous values of weights Pᵢ, during operation 70, the value of computed CTFC is as follows:

CTFC=Σᵢ₌₁¹TFIᵢ*Pᵢ=2*1+1*3+1*9=14

Once base station 4 has calculated the CTFC, in a step 72, it determines the TFCI that is associated with the calculated CTFC. For example, during step 72, base station 4 uses a table which is identical with table 38. As an example, we assume that the TFCI associated with the value “14” equals “2”.

Next, in a step 76, the TFCI value is coded in each frame of the transmitted data and each frame is transmitted over the air by transceiver 18.

On the receiving side, in a step 80, each frame is received by transceiver 30. Then, in a step 82, unit 32 extracts the TFCI from each frame and transmits the extracted TFCI to unit 34.

In step 84, unit 34 recognizes the CTFC value by using the extracted TFCI and table 38. For example, unit 34 recognizes that the CTFC associated with “2” equals “14”.

In step 86, unit 40 retrieves the TFIᵢ for each transport channel by using the recognized CTFC and the data stored in memory 42.

More precisely, during an operation 88, module 46 computes a weight Pᵢ associated with each transport channel TrCHᵢ by using relation (1). Then, during an operation 90, module 48 determines the TFᵢ of each transport channel by using the recognized CTFC and weights Pᵢ. This operation 90 is described in greater detail in FIG. 3.

At the beginning of operation 90, in step 100, the value of the integer index i is set to the number of transport channel “I” and the value of an integer F is set to the value of the recognized CTFC.

Next, in step 102, if it is determined that the value of index i is less than 1, then module 48 proceeds to step 104. In step 104, the value of each TFIᵢ for i=0 to i=I is set to “0” and operation 90 ends.

If during step 102, module 48 determines that the value of index i is greater than or equal to unity, it sets the value of TFIᵢ to “0” in step 106. Subsequently, in step 108, the value of a variable W is set to the current value of integer F minus the weight Pᵢ.

Then, in step 110, if module 48 determines that the value of variable W is greater than or equal to “0”, it proceeds to step 112. In step 112, module 48 sets the current value of integer F to the current value of variable W and increments the value of TFIᵢ by unity. After step 112, the algorithm returns to step 108.

If during step 110, module 48 determines that the value of variable W is less than “0”, it proceeds to step 114. In step 114, the current value of TFIᵢ is stored and the value of index “i” is decremented by unity. After step 114, the algorithm returns to step 102.

Thus, as illustrated by the algorithm of FIG. 3, the weights Pᵢ and the corresponding transport channels TrCHᵢ are treated in a descending order. For each treated transport channel, the weight Pᵢ of this transport channel is repeatedly subtracted from the current value of integer F until variable W becomes negative. When variable W becomes negative, variable F is equal to the remainder of a division of the initial value of F by Pᵢ and the value of TFIᵢ is identical with the whole part of the number resulting from the division of the initial value of F by Pᵢ. The initial value of integer F is the value of F before starting the iteration of steps 108, 110 and 112 to repeatedly decrement F by Pᵢ.

Operation 90 is fast because it does not involve dividing operations or flooring operations. Only subtractions are used. Thus, the algorithm of FIG. 3 can be executed faster than a conventional method on a processor that has no dedicated multiplier units such as an ARM9 processor. In fact, a division on an ARM9 processor is executed in fifty cycles, whereas a subtraction is executed in only one cycle.

Moreover, it can easily be seen that if such algorithm has to be performed more than once, like for example in UMTS user equipment, having a fast algorithm greatly improves the overall performance of the user equipment. In particular, when the data of the transport channels are encoded with DTX (Discontinuous Transmission) bits inserted at flexible positions, all the CTFC tables have to be iteratively explored. As an example, for a 384 kbps class (refer to specification 3GPP TS 25.306), the CTFC table contains up to 128 values.

1. A method of retrieving a transport format indicator from a calculated transport format combination the calculated transport format combination having been computed by means of the following relation:
$${P}_{i} = {\prod }_{j = 0}^{i - 1} {L}_{j}$$
$$CTFC = {\sum }_{i = 1}^{I} {TFI}_{i} * {P}_{i}$$
where:
Lₒ=1;
i is an index varying by integer steps h m 1 to I;
I is the total number of transport channels in one coded composite transport channel;
Lⱼ is the number of available transport formats for a transport channel j
Pᵢ is a weight associated with transport channel i and
TFIᵢ is the transport format indicator of transport channel i, the value TFIᵢ being equal to a whole part of a division of an integer by weight Pᵢ the value of the integer F being a function of the CTFC value,
wherein the whole part is determined by repeatedly decrementing the integer F by the weight Pᵢ.

2. The method according to claim 1, wherein:
the TFIᵢ values are determined in descending order of the index i; and,
the initial value of integer F is equal to the remainder of the previous division.

3. The method according to claim 2, wherein the initial value of integer F is equal to the value of CTFC for the determination of the TFI_{I} value.

4. A device for retrieving a transport format indicator transport format combination the calculated transport format combination having been computed by means of the following relation:
$${P}_{i} = {\prod }_{j = 0}^{i - 1} {L}_{j} , \\ CTFC = {\sum }_{i = 1}^{I} {TFI}_{i} * {P}_{i}$$
where:
Lₒ=1;
i is an index varying by integer steps from 1 to I;
I is the total number of transport channels in one coded composite transport channel;
Lⱼ is the number of available transport formats for a transport channel j
Pᵢ is a weight associated with transport channel I and
TFIᵢ is the transport format indicator of transport channel i, the value TFIᵢ being equal to a whole part of a division of an integer (Fᵢ by weight Pᵢ, the value of the integer F being a function of the CTFC value,
wherein the device comprises a transport format indicator determining module adapted to determine the whole part by repeatedly decrementing integer F by weight Pᵢ.

5. The device according to claim 4, wherein the determining module is implemented in a processor which has no dedicated multiplier unit to perform a fast division.

6. A mobile phone comprising a device according to claim 4 for retrieving the transport format indicator
